(19) United States
(12) Patent Application Publication
(10) Pub. No.: US 2014/0301101 A1
(43) Pub. Date: Oct. 9, 2014

(54) Multifunctional Multiple Color Center High Mounted Stop Lamp

(71) Applicant: Mr. Derek Terrell Russ, (US)

(72) Inventor: Derek Terrell Russ, Gretna, LA (US)

(21) Appl. No.: 13/858,085

(22) Filed: Apr. 7, 2013

(51) Int. Cl. B60Q 1/44

(52) U.S. Cl. CPC B60Q 1/44
USPC 362/520; 362/541

(57) ABSTRACT

The present invention relates generally to a center high mounted stop lamp for a vehicle, such as a four- or two or three-wheeled motor vehicle, which makes a vehicle behind aware of its approach to a vehicle ahead in accordance with an actuation of the latter's brake system. In particular, it relates to a multifunctional multiple color center high mounted stop lamp for mounting in the interior or exterior of the vehicle, which includes multiple light emitting diodes (LEDs) configured to emit different colors through a single optical lens. This present invention enhances the safety of the vehicle by combining the advantages of a center high mounted stop lamp with the advantages of a hazard warning/signaling device. Combining these advantages into the multifunctional multiple color center high mounted stop lamp cooperate to increase overall vehicle safety and creates a synergistic effect.

### CROSS-REFERENCE TO RELATED APPLICATIONS

This application claims the benefit of provisional patent application No. 61/649,848, filed 2012 May 21 by the present inventor.

### STATEMENT PURSUANT TO 37 CFR 1.125(b)

The following substitute specification contains no new matter.

### BACKGROUND

### Description of Prior Art

Normally-on brake lights are provided on vehicles to signal drivers of other vehicles that the brake system of the subject vehicle has been actuated. In order to reduce rear end collisions, center high mounted stop lamps (CHMSL) have been added to each vehicle to further enhance visibility of its normally-on brake lights when they are activated. However, conventional center high mounted stop lamps do not relay information to on-coming vehicles pertaining to warning the occupant of the on-coming vehicle that the subject vehicle stands on the road in the way, where there may be danger of collision with the on-coming vehicle and danger of personal injury to the occupant of the on-coming vehicle.

There are known hazard warning/signaling devices for use on vehicles, an example of which is a hazard flashing system, in which emergency light flashers are attached to the lower portions of a vehicle. A disadvantage of this type of warning device is that it is not easily seen in the day time and can be readily obstructed by persons standing on the road working around the vehicle. Other known hazard warning/signaling devices have included reflective triangles, flashing lights or beacons, strobe lights, and flashing or sequentially illuminated directional arrows.

All safety and law enforcement vehicles have enjoyed safety features of hazard lights that are substantially visible on roads and highways. Personal motor vehicles should also enjoy these safety features in a practical manner, although it would not be an aesthetically appeasing and a commercially successful design element if vehicle designers were to design hazard lights in the same manner as an external or internal component of the vehicle's design, excepting lights that motor vehicles currently utilize.

### OBJECTS AND SUMMARY

The above-mentioned and other problems become solved by applying the principles and teachings associated with the hereinafter described multifunctional multiple color center high mounted stop lamp. An added, practical, and easy to employ multifunctional multi-color center high mounted stop lamp would enhance a hazard flashing system of any vehicle and is of a size and character to be visible at a great distance.

The present invention relates generally to a center high mounted stop lamp for a vehicle, such as a four- or two or three-wheeled motor vehicle, which makes a vehicle behind aware of its approach to a vehicle ahead in accordance with an actuation of the latter's brake system. In particular, it relates to a multifunctional multiple color center high mounted stop lamp for mounting in the interior or exterior of the vehicle, which includes multiple light emitting diodes (LEDs) configured to emit different colors through a single optical lens. This present invention enhances the safety of the vehicle by combining the advantages of a center high mounted stop lamp with the advantages of a hazard warning/signaling device. Combining these advantages into the multifunctional multiple color center high mounted stop lamp cooperate to increase overall vehicle safety and creates a synergistic effect.

In a basic sense, the multifunctional multiple color center high mounted stop lamp includes a plurality LEDs aligned in a single row. Each of the plurality of LEDs are configured to emit two different colors of light-red and amber-through a single optical lens. As a result, the multifunctional multiple color center high mounted stop lamp is capable of producing a single light color red in a first mode when the vehicle's ignition is engaged, and a single light color amber, single light color red, or dual light colors red and amber in a second mode when the vehicle's hazard flashing system, or the like, is engaged, each mode being capable of operating simultaneously. For example, the multifunctional multiple color center high mounted stop lamp illuminates a generally constant red upon actuation of the brake pedal in a driving mode and red and/or amber colors upon engagement of the vehicle's hazard flashing system in a warning/emergency mode or traffic directional mode, such as “arrow stick” configuration.

Advantageously, a passenger, or an emergency, vehicle may be equipped with a single multifunctional multiple color center high mounted stop lamp, which is capable of displaying multiple colors and patterns instead of being equipped with a center high mounted stop lamp, capable of displaying only one red color, and a reflective triangle, or the like, which are each limited to a single function. Furthermore, the use of multiple devices is more expensive due to the purchase and installation of each device.

In one embodiment, the multifunctional multiple color center high mounted stop lamp has a housing with a base and a cover. The housing has a plurality of transparent modules that are equally positioned adjacent to each other along the length of the housing. Each module includes a plurality of LED packages and a secondary optic lens, which is typically used with high powered LEDs to narrow down the angle of light output and project the light outwards. Each LED package includes an individual diode, two light emitting chips, a set of leads connecting the individual diode to the light emitting chips and a primary optical lens. The LED packages as well as the individual diodes are aligned side-by-side creating a single row within any particular module. Each individual diode in the LED package will produce a light in a first color or a second color when properly biased. To appropriately bias the individual diode, a drive signal from one of the pair of LED chips is sent through the leads to trigger the individual diode to produce a desired color.

Still other objects of the present invention will become apparent to those skilled in the art from the following description wherein there is shown and described a preferred embodiment of this invention, simply by way of illustration of one of the modes best suited to carry out the invention. As it will be realized, the invention is capable of other different embodiments and its several details are capable of modification in various and obvious aspects, all without departing from the invention. Accordingly, the drawings and description will be regarded as illustrative in nature and not as restrictive.

### BRIEF DESCRIPTION OF THE DRAWINGS

FIG. 1 shows a block diagram showing the principles of the present invention;

FIG. 2 shows a block diagram of a spoiler with a multifunctional multiple color center high mounted stop lamp in accordance with the present invention;

FIG. 3 shows a rear view of a vehicle incorporating the present invention;

FIG. 4 shows a rear view of a vehicle incorporating the present invention;

FIG. 5 shows a rear view of a vehicle incorporating the present invention;

FIG. 6 shows a top view in accordance with one embodiment of the present invention;

FIG. 7 shows a top view in accordance with one embodiment of the present invention;

FIG. 8 shows a front view in accordance with one embodiment of the present invention of an individual module; and

FIG. 9 shows a front view in accordance with one embodiment of the present invention of an input device.

Reference Numerals

10 Center High Mounted Stop Lamp
12 Brake Pedal
14 Normally-on Brake Light
16 Signal Indicator
18 Vehicle
20 Housing
22 Battery
24 Spoiler
26 Trailing Edge of Roof
28 Base
30 Cover
32 Back light
34 LED Package
36 Light Emitting Chip
38 Light Emitting Chip
40 Primary Optical Lens
42 Secondary Optical Lens
44 Operating Device or Controller
46 Input Device
48 Input Button
50 Input Button
52 Input Button
54 Hazard Flasher System Button
56 Plurality of LEDs
58 Brake line

### EMBODIMENTS—DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention and like numerals represent like details in the various figures. Also, it is to be understood that other embodiments may be utilized and that process or other changes may be made without departing from the scope of the present invention. The following detailed description is, thus, not to be taken in a limiting sense.

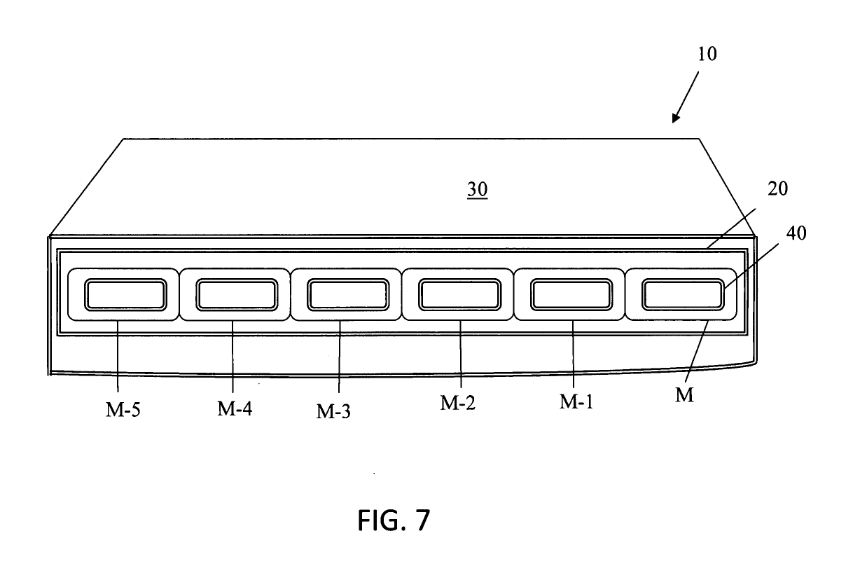

As best perhaps best illustrated in FIG. 7, the present invention relates to a multifunctional multiple color center high mounted stop lamp 10. Specifically, the multifunctional multiple color center high mounted stop lamp includes a housing 20 with a base 28 and a cover 30. The base 28 and cover 30 of the housing 20 are designed to direct or project light from the multifunctional multiple color center high mounted stop lamp 10 out of the vehicle 18 to provide external illumination to other motorists and pedestrians. Moreover, the base 28 and cover 30 prevent the light from the multifunctional multiple color center high mounted stop lamp 10 from distracting the driver of the vehicle.

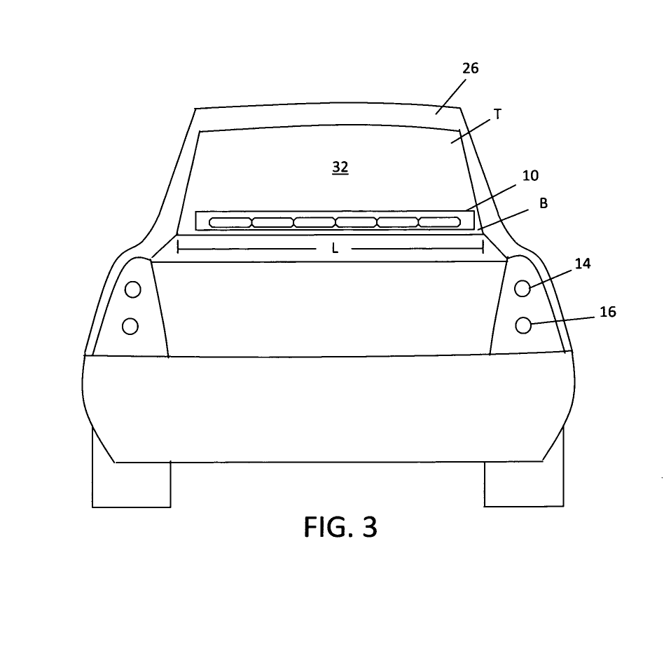

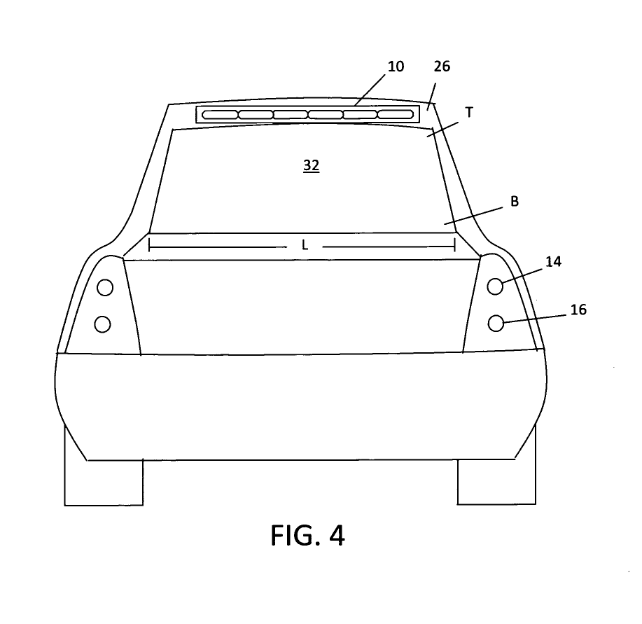

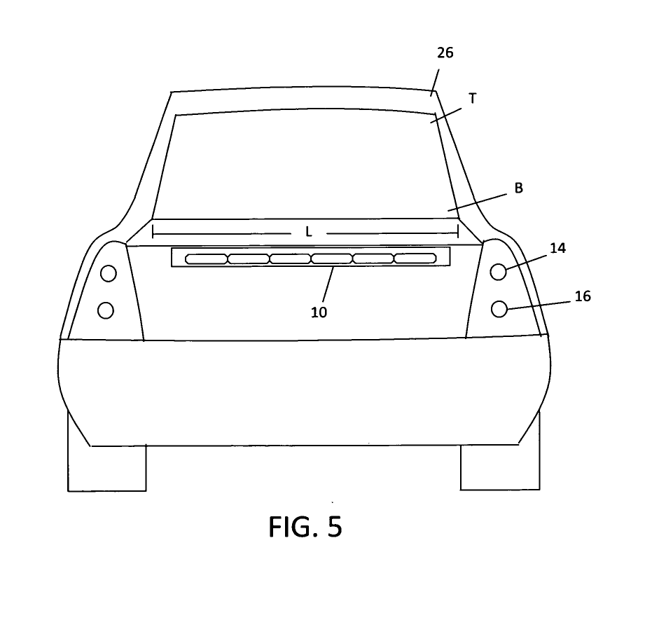

The base 28 of the multifunctional multiple color center high mounted stop lamp 10 may be mounted within a back light 32 of a vehicle 18 such that the multifunctional multiple color center high mounted stop lamp 10 extends longitudinally along the length L of the bottom B of the back light 32. FIG. 3. In another embodiment, the cover 30 of the multifunctional multiple color center high mounted stop lamp 10 may be mounted within a back light 32 of a vehicle 18 such that the multifunctional multiple color center high mounted stop lamp 10 extends longitudinally along the length L of the top T of the back light 32. In yet another embodiment, the housing 20 may be mounted within the back light 32 such that the multifunctional multiple color center high mounted stop lamp 10 extends longitudinally along the length L of the bottom B or top T of the back light 32. Alternatively, each module may have a housing, which may be fixed to a glazing material on the back light 32. In yet another embodiment, the housing 20 may be attached to the rear opening fixture, or adjacent to the rear opening fixture of the vehicle. FIG. 5. In yet another embodiment, the multifunctional multiple color center high mounted stop lamp 10 can also be mounted near the trailing edge 26 of the roof adjacent to the back light 32 or can also be mounted in a spoiler or wing 24. FIGS. 4 and 2. In addition to passenger vehicles, the multifunctional multiple color center high mounted stop lamp 10 may be used in conjunction with law enforcement vehicles, other emergency vehicles, tow trucks or the like.

Depending on whether the multifunctional multiple color center high mounted stop lamp 10 is mounted in the interior or exterior of the vehicle 18, the modules or light heads (M, M-1, M-2 . . . M-5) may not necessarily be coplanar. For example, the modules may be staggered to accommodate the curvature in the back light 32 (i.e., M is closer to the window than M-2 and so on). On the other hand, the modules may be substantially coplanar in a multifunctional multiple color center high mounted stop lamp 10 mounted to the rear opening fixture, or mounted adjacent to the rear opening fixture of the vehicle. FIG. 5.

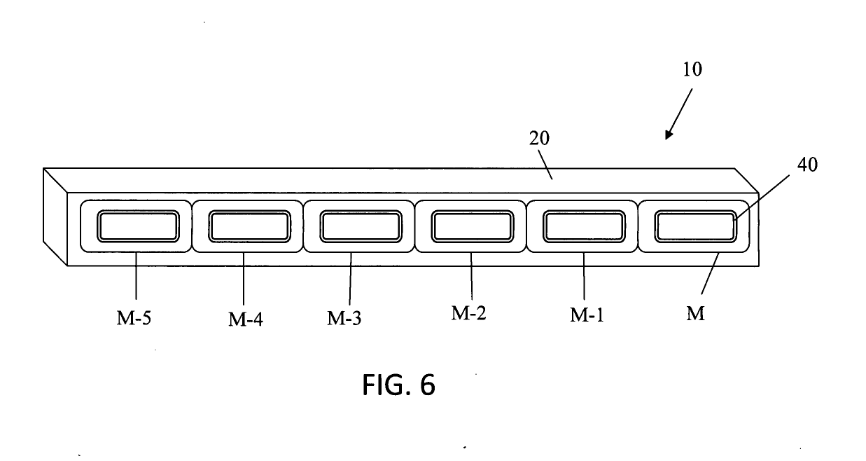

The modules M are transparent, clear, or colored and are substantially equally positioned adjacent to each other along the length of the housing 20. FIGS. 6 and 7. The housing 20 of the multifunctional multiple color center high mounted stop lamp 10 is a single housing with a plurality of modules (M, M-1, M-2 . . . M-5). Of course, the number of modules within the housing 20 may vary depending on the type of application and the mounting options for the multifunctional multiple color center high mounted stop lamp 10 in a particular vehicle. It should, therefore, be appreciated that the housing may comprise one module. Also, the modules M may take on any shape, such as an oval, square, rectangle, or the like, and are not limited to the shape depicted in the drawings.

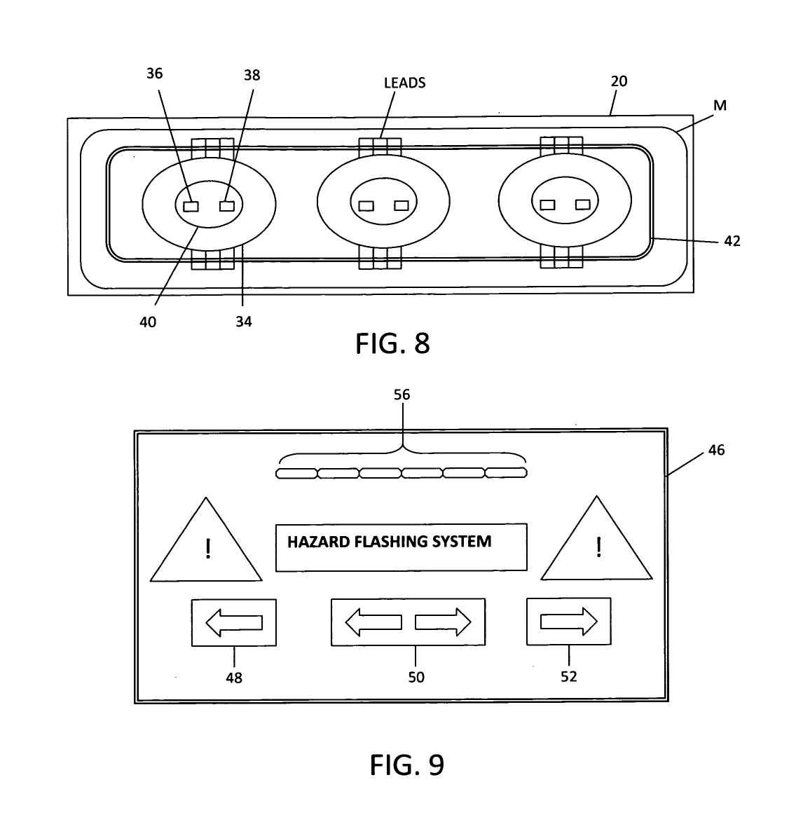

Each module M includes a plurality of LED packages 34 and a secondary optic lens 42, which is typically used with high powered LEDs to narrow down the angle of light output and project the light outwards (similar to a flashlight). FIG. 8. In this embodiment, there are three LED package 34 positioned within the module M. However, it should be appreciated that a greater or lesser number of LED packages 34 may be positioned within each module M depending on the size and particular application for the multifunctional multiple color center high mounted stop lamp 10.

Each LED package 34 includes an individual diode D, two emitting chips 36, 38, a set of leads connecting the individual diode D to the light emitting chips 36, 38 and a primary optical lens 40. FIG. 8. The LED packages 34 as well as the individual diodes are aligned side-by-side creating a single row within the particular module. Importantly, each individual diode in the LED package 34 will produce a light in a first color and a second color when properly biased.

To appropriately bias the individual diode, a drive signal from one of the pair of LED chips 36, 38 within each LED package 34 is sent through certain leads to trigger the individual diode to produce the following two color combination: red/amber. In other words, one of the chips corresponds to the first color (i.e., the left chip=red) and the other of the chips corresponds to the second color (i.e., the right chip=amber). Of course, the LED package 34 of the multifunctional multiple color center high mounted stop lamp 10 can be limited to a single color LED instead of a multiple color LED without departing from the scope of the present invention.

The light emitting chips 36, 38 drive the color of the individual diode within the LED package 34 through the set of leads. Center high mounted stop lamps previously employed LEDs that were a single color (i.e., red, amber, white/clear). In the past, the only way to produce two colors was to have two diodes. In this case, the individual diodes are driven by the light emitting chips 36, 38 to produce the desired different colors. Specifically, the individual diode emits either red or amber through the primary optical lens 40. The light output generated by the individual diode is projected through the primary optical lens 40 creating an optical illusion that there is a single LED that is actually changing color.

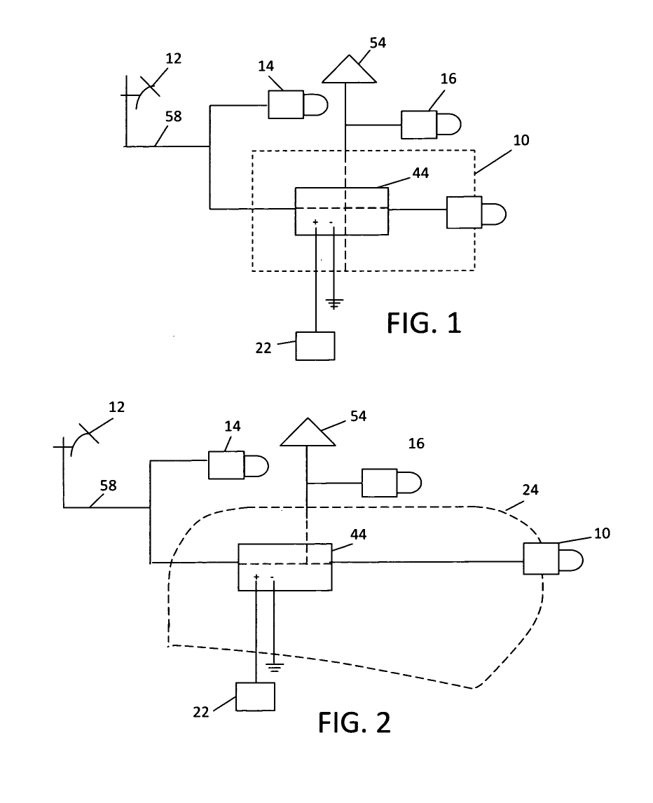

The LED packages 34 are situated in electrical communication with an operating device or controller 44 capable of selectively activating the LED packages 34 in the multifunctional multiple color center high mounted stop lamp 10. Activation occurs upon application of a digital signal (Logic 0 or Logic 1) generated from a power source 22. Also, the operating device or controller 44 includes circuitry and is electrically connected to the LED packages 34 through a cable (not shown). The operating device or controller 44 could be a microprocessor, ASIC, collection of chips capable of performing functions or the like. As shown in FIGS. 1 and 2, the operating device or controller 44 preferably is interconnected with a conventional electronic brake light line 58 which provides power to the normally-on brake lights 14 of vehicle 18 in response to movement of brake pedal 12. Alternately, movement of the brake pedal 12 actuates the brake switch (not shown), or other sensor, which closes a circuit to provide power to line 58. Alternatively, actuation of the brake pedal 12 supplies a ground to the normally-on brake lights 16. The operating device or controller 44 is positioned local to, adjacent to, or within multifunctional multiple color center high mounted stop lamp 10 and is inserted in brake light line 58. This allows the operating device or controller 44 to determine whether an actuation of the brake pedal 12 is passed through to the normally-on brake lights 14.

In addition, an optional LED indicator input device 46 for use in conjunction with the multifunctional multiple color center high mounted stop lamp 10 is illustrated in FIG. 9. The input device 46 is in electronic communication with the operating device or controller 44. The input device 46 is capable of being mounted within the same vehicle that the multifunctional multiple color center high mounted stop lamp 10 is mounted. In one embodiment, the input device 46 may be mounted near the operator's seat, such as within a center console, or in another embodiment, may be a liquid crystal display (LCD) monitor in the interior of the vehicle and mounted within a dashboard such that the operator may easily access the input device 46. The multifunctional multiple color center high mounted stop lamp 10 described herein is not required to be operated by the input device 46. Instead, it may be operated by other input devices or switch control systems as long as there are sufficient control/trigger wires and switches to accomplish the functions described herein.

The input device 46 includes a touch screen display and a plurality of user input buttons 48, 50, and 52 for activating various signal modes discussed above. FIG. 9. Each button corresponds to a specific pattern: 48 left directional arrows; 50 center-out directional arrows; 52 right directional arrows. The input device 46 is connected to a hazard flasher system button 54, signal indicators 16 and LED packages 34 of the multifunctional multiple color center high mounted stop lamp 10 via the cable.

During use, the operator of the vehicle may select the desired flash pattern by pushing one of the buttons on the input device 46. The input device 46 will display the same pattern on a plurality of LEDs 56 on the LCD monitor as the multifunctional multiple color center high mounted stop lamp 10. In order to select any arrow pattern, the operator initially selects/pushes the hazard flashing system button 54 to activate the hazard flasher system and then selects/pushes the desired traffic function button (i.e. 48 for left directional arrow; 50 for center-out directional arrows; or 52 for right directional arrow) which becomes displayed on the LCD monitor. The input device 46 and multifunctional multiple color center high mounted stop lamp 10 may be programmed such that when any arrow function is selected by the operator, traffic mode automatically flashes red LEDs also.

Once the operator selects the particular application he/she wants the multifunctional multiple color center high mounted stop lamp 10 to perform by pushing the desired input button on the input device 46, a signal is sent to the operating device or controller 44. In turn, the operating device or controller 44 activates the particular light emitting chip 36, 38 (either red or amber) embedded in the LED package 34 to drive the desired color for the individual diode. In this manner, the multifunctional multiple color center high mounted stop lamp 10 is capable of producing multiple colors and patterns through the single optical lens 40.

In the traffic directional mode, the LEDs of the housing 20 of the multifunctional multiple color center high mounted stop lamp 10 display amber in various patterns depending on the traffic situation, including left, right and center-out directional signals. For example, when the vehicle is involved in a traffic accident or is broken down in the right lane of traffic, the driver may desire to direct other drivers to clear the right lane and use the left lane(s) of the road/highway or vice-versa if the accident or vehicle is in the left lane. In addition, if there is a multiple-lane highway and the vehicle obstructs the middle lane, it may be desirous to use the center-out directional mode.

In left directional signal mode corresponding to input button 48, the LEDs in module M of the housing 20 display amber, followed by the LEDs in the second module M-1, followed by the LEDs in the third module M-2 and so on until all six modules (M through M-5) display amber. This pattern is repeated until the left directional signal mode is turned OFF or changed to another mode. It takes about 0.6 seconds for all of the modules to display amber, so there is approximately 0.1 seconds time lapse between the first module displaying amber and then the second module displaying amber and so on. It should be appreciated that the timing and type of pattern may be adjusted to varying lengths and patterns.

Similarly, in right directional signal mode corresponding to input button 52, the LEDs in module M-5 of the housing 20 displays amber, followed by the LEDs in the fifth module M-4, followed by the LEDs in the fourth module M-3, and so on until all six modules (M-5 through M) display amber. This pattern is repeated until the right directional signal mode is turned OFF or changed to another mode. Additionally, in the center-out directional mode corresponding to input button 50, LEDs in module M-2 and the LEDs in module M-3 display amber simultaneously, followed by the LEDs in module M-1 and the LEDs in module M-4 and so on until all of the modules are displaying amber. This pattern is repeated until the center-out directional mode is turned off or changed to a different mode.

In the embodiments detailed above, the LED packages 34 (which displays the red flashing pattern upon activation of the brake pedal) includes the first chip 36 that corresponds to the color red and the second chip 38 that corresponds to the color amber. This, the multifunctional multiple color center high mounted stop lamp 10 is able to display a red flashing pattern in the braking mode. Moreover, due to the presence of the second chips corresponding to the color amber, the multifunctional multiple color center high mounted stop lamp 10 is able to display amber in traffic directional mode.

The foregoing description if a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention.

What is claimed is:

1. A center high mounted stop lamp for a vehicle, said center high mounted stop lamp comprising:
the center high mounted stop lamp configured to be mounted at a rear portion of the vehicle and operable in response to actuation of a brake pedal by a driver of the vehicle, said center high mounted stop lamp comprising a plurality of light emitting diodes aligned in a single row, each of the plurality of light emitting diodes configured to emit two different colors of light, said each of the plurality of light emitting diodes being actuated to illuminate one color—red—at a generally constant intensity while the brake pedal is actuated; and
an operating device or controller

2. The center high mounted stop lamp of claim 1, wherein said center high mounted stop lamp is capable of producing a single color pattern and/or a dual color pattern.

3. The center high mounted stop lamp of claim 1, further comprising a housing having a base and a cover.

4. The center high mounted stop lamp of claim 3, further comprising a plurality of modules positioned within the housing.

5. The center high mounted stop lamp of claim 4, wherein the plurality of modules are equally positioned adjacent from each other along the length of the housing.

6. The center high mounted stop lamp of claim 4, wherein each of the plurality of modules includes a secondary optic lens covering all of the plurality of light emitting diodes in each of said plurality of modules.

7. The center high mounted stop lamp of claim 4, further comprising a plurality of light emitting diodes packages located in each of the plurality of modules.

8. The center high mounted stop lamp of claim 7, wherein the plurality of light emitting diode packages correspond equally to each of the plurality of light emitting diodes.

9. The center high mounted stop lamp of claim 7, wherein each of the plurality of light emitting diode packages includes a pair of light emitting chips corresponding equally to each of the plurality of light emitting diodes.

10. The center high mounted stop lamp of claim 9, wherein a first one of the pair of light emitting chips configured to provide a red color to the corresponding one of the light emitting diodes.

11. The center high mounted stop lamp of claim 9, wherein a second one of the pair of light emitting chips configured to provide an amber color to the corresponding one of the light emitting diodes.

12. The center high mounted stop lamp of claim 6, wherein each of the plurality of light emitting diode packages includes a primary optical lens.

13. The center high mounted stop lamp of claim 1, further comprising the operating device or controller in electric communication with each of the plurality of light emitting diodes.

14. The center high mounted stop lamp of claim 1, further comprising an input device having multiple user input buttons for selecting a desired pattern.

15. A center high mounted stop lamp for a vehicle, said center high mounted stop lamp comprising:
a housing including a plurality of modules, each of the plurality of modules having at least two light emitting diode packages;
each of the at least two light emitting diode packages including a pair of light emitting chips connecting to a single light emitting diode;
each of the single light emitting diodes are aligned in a single row and configured to emit two different colors of light upon receipt of a signal from the pair of light emitting chips,
whereby the multifunctional multicolor center high mounted stop lamp is capable of producing a single color light pattern and a dual color light pattern.
